(19) United States
(12) Patent Application Publication
(10) Pub. No.: US 2026/0337718 A1
(43) Pub. Date: Oct. 29, 2026

(54) LFP BATTERY RECYCLING PLANT AND PROCESS

(71) Applicant: BASF SE, Ludwigshafen am Rhein (DE)

(72) Inventors: Maximilian RANG, Ludwigshafen (DE); Wolfram WILK, Ludwigshafen (DE); Marc DUCHARDT, Ludwigshafen (DE); Anne-Marie Caroline ZIESCHANG, Ludwigshafen (DE); Fabian SEELER, Ludwigshafen (DE); Wolfgang ROHDE, Ludwigshafen (DE); Kerstin SCHIERLE-ARNDT, Ludwigshafen (DE)

(21) Appl. No.: 19/121,478

(22) PCT Filed: Oct. 31, 2023
(86) PCT No.: PCT/EP2023/080416

§ 371 Date: Apr. 16, 2025

(30) Foreign Application Priority Data
Nov. 3, 2022 (EP) 22205370.4

(51) Int. Cl. C22B 7/00; C22B 15/00; C22B 26/12; H01M 10/54

(52) U.S. Cl. CPC C22B 7/007; C22B 7/001; C22B 15/0006; C22B 26/12; H01M 10/54

(57) ABSTRACT

Disclosed herein are a plant for recycling used batteries, in particular lithium iron phosphate (LFP) batteries, and a process for recovering valuable materials from used batteries.

### FIELD OF THE INVENTION

The present disclosure relates to a plant for recycling used batteries, in particular lithium iron phosphate (LFP) batteries, and to a process for recovering valuable materials from used batteries.

### BACKGROUND

Lithium ion battery materials are complex mixtures of various elements and compounds. For example, lithium iron phosphate battery materials contain valuable metals such as lithium, aluminum, copper, and/or others. It may be desirable to recover various elements and compounds from lithium iron phosphate battery materials. For example, it may be advantageous to recover lithium and/or copper.

The lithium iron phosphate battery (LiFePO₄ battery) or LFP battery (lithium ferrophosphate) is a type of lithium-ion battery using lithium iron phosphate (LiFePO₄) as the cathode material, and a graphitic carbon electrode with a metallic backing as the anode. Because of its lower cost, high safety, low toxicity, long cycle life and other factors, LFP batteries are finding a number of roles in vehicle use, utility scale stationary applications, and backup power. Accordingly, there is a need for devices and processes for recycling used LFP batteries.

CN 112 768 800 A discloses a recycling method of a lithium iron phosphate cathode material. The recycling method comprises dissolving the lithium iron phosphate cathode material in an acid solution, and adding an oxidizing agent to oxidize undissolved copper in the recovered material to obtain filtrate I; adding reduced iron powder into the filtrate I to obtain filtrate II; adding lithium carbonate and/or lithium bicarbonate into the filtrate II to fully precipitate aluminum ions to obtain filtrate Ill; adding a ferric iron salt or phosphoric acid into the filtrate Ill to adjust a molar ratio of iron to phosphorus in the filtrate Ill, so that the molar ratio of iron to phosphorus in the filtrate Ill is (0.9-1.2):1, and adding an oxidizing agent and an acid solution at the same time to oxidize the ferrous iron salt in the filtrate Ill into ferric iron without generating iron phosphate precipitate; and heating the reaction liquid obtained in the step 4 to 60-100 °C, and adding lithium carbonate and/or lithium bicarbonate to fully precipitate the iron phosphate, so as to obtain an iron phosphate solid and a filtrate 4; wherein the fourth filtrate is used for preparing lithium carbonate, and the prepared lithium carbonate is used in the third step or the fifth step.

CN 108 110 357 A discloses a method for recovering valuable metals from a waste lithium iron phosphate battery cathode material. The method specifically comprises the following steps: (1) fully roasting and oxidizing the disassembled, broken and ground lithium iron phosphate battery cathode material, so that Fe and Li metal elements in the battery cathode material are generated into Fe₂O₃, FePO₄ and Li₃PO₄ through being roasted and oxidized; (2) placing a roasted material that is fully-roasted and oxidized in the step (1) in a dilute acid solution for soaking, so that Li₃PO₄ in the roasted material is fully dissolved and filtered to realize the separation of the Li₃PO₄ in the roasted material from the Fe₂O₃ and the FePO₄; (3) taking a filtrate after treatment in the step (3) and regulating the filtrate to be alkaline, so that Li₃PO₄ in the filtrate is directly separated out into a precipitate.

CN 114 044 503 A discloses a method for separation, impurity removal and regeneration of a lithium iron phosphate waste electrode, wherein the method comprises the steps: grinding, crushing and screening the lithium iron phosphate waste electrode to obtain lithium iron phosphate waste powder and aluminum particles with the aluminum content of less than 0.2% by mass, mixing the obtained lithium iron phosphate waste powder with zinc oxide (preferably activated zinc oxide), carrying out negative pressure roasting at the temperature of 650-675 °C, removing PVDF and F, demagnetizing and decarbonizing to obtain a mixture of ferric oxide and lithium ferric phosphate with quite low contents of Al and F, and using the mixture of ferric oxide and lithium ferric phosphate as a raw material to obtain lithium iron phosphate.

CN 107 785 571 A discloses a method for recycling and reutilizing a cathode material of a lithium iron phosphate battery. The method comprises the following steps: 1) heating waste lithium iron phosphate in air atmosphere, at 500 to 800 °C to fully oxidize the material; 2) adding a carbon source and a dispersion medium to the material obtained in step 1, performing ball grinding, fully mixing, and then performing drying treatment in a drying box on the obtained mixture; 3) preserving the heat of the mixture which is obtained in step 2 for 6 to 8 hours.

CN 112 661 130 A discloses a method of recycling a lithium iron phosphate battery cathode. The method comprises the following steps: crushing a lithium iron phosphate battery cathode to obtain 3-6 cm cathode chips, roasting the cathode chips in a rotary kiln under air atmosphere, wherein the rotary kiln comprises a preheating section and a roasting section, the temperature of the roasting section is 400-650 °C, and the temperature difference between roasting and preheating is 200-300 °C; and finally screening to obtain active cathode powder.

CN 111 924 817 A discloses a method for comprehensively utilizing a waste lithium iron phosphate cathode material. The method comprises the following steps: leaching the waste lithium iron phosphate cathode material with an acid solution, adjusting the iron-phosphorus ratio and the pH value of the leachate to strong acidity, converting ferrous ions into iron ions through an oxidation reaction to generate iron phosphate precipitates, and carrying out liquid-solid separation to obtain hydrated iron phosphate and a lithium-containing solution; removing heavy metal ions from the lithium-containing solution through a precipitation method, and carrying out liquid-solid separation to obtain heavy metal precipitation slag and a lithium-containing purified solution; and adding a lithium ion precipitant into the lithium-containing purified solution, adjusting the pH value to be weakly acidic or alkaline, carrying out a lithium ion precipitation reaction, and carrying out liquid-solid separation to obtain a lithium salt product.

CN 109 852 807 A discloses a method of performing oxidation treatment on waste lithium ion batteries comprising adding waste lithium ion battery powder into an acidic water solution to obtain a mixed slurry; inputting oxidizing gas to the mixed slurry with an aerating device, and performing oxidizing leaching; after the reaction is completed, regulating the pH of the reaction slurry with an acid regulating reagent to remove less valuable metal ions, and then performing solid-liquid separation to obtain lithium-enriched purified liquid and reaction tailings; and then performing lithium precipitation and solid-liquid separation on the purified liquid so as to obtain lithium carbonate products or lithium phosphate products.

CN 109 921 087 A discloses a comprehensive treatment method of a waste lithium iron phosphate battery. The comprehensive treatment method comprises manual disassembly; drying and pyrolysis; crushing and separating; heat treatment, acid leaching; filter pressing and washing; transformation; alkalization and impurity removal; and preparation of magnesium chloride.

CN 111 187 913 A discloses a method of recovering lithium and copper from a waste lithium iron phosphate battery selectively. The method comprises mixing the waste lithium iron phosphate battery with an inorganic acid and oxygen to react at 96-150 °C, and carrying out solid-liquid separation thereafter to obtain a leachate and an iron phosphate leaching residue, mixing the leachate with a separating agent to separate copper in the leachate, and then adding an alkaline substance to adjust the pH to remove impurities iron and aluminum to obtain a purified liquid; and precipitating the purified liquid and sodium salt to obtain a lithium product.

KIM, Seoa et al.: “A comprehensive review on the pretreatment process in lithium-ion battery recycling”, Journal of cleaner production, vol. 294 (2021) 126329 provides a survey of pretreatment processes used in Li-ion battery recycling. The processes include discharge, dismantling, comminution, classification, separation, dissolution, and thermal treatment.

TANAKA, Futoshi et al.: “Dehydrofluorination behavior of poly(vinylidene fluoride) during thermal treatment using calcium carbonate”, Thermochimica Acta vol. 702 (2021) 178977 investigates HF emission behavior during thermal treatment of poly(vinylidene fluoride) used as binder in Li-ion batteries. Calcium carbonate is added to suppress the emission of HF.

It is an object of the present disclosure to provide an improved recycling plant for used LFP batteries and an improved recycling process for used LFP batteries.

### SUMMARY OF THE INVENTION

A plant for recycling lithium iron phosphate (LFP) battery materials, such as used LFP batteries, is provided which comprises a comminuting device to comminute LFP battery materials in a comminuting space. The plant includes a heat treatment device, arranged downstream of the comminuting device, to dry and heat the comminuted LFP battery material. The plant includes an intermediate storage device arranged between the comminuting device and the heat treatment device. The plant includes an oxidation device for oxidizing the heat-treated comminuted LFP battery material. In some embodiments, the plant further comprises reactors for recovering valuable materials from the oxidized LFP battery material.

A process for recycling lithium iron phosphate battery material, such as used LFP batteries, also is provided. The process comprises comminuting the LFP battery material, drying the comminuted LFP battery material and heating the comminuted LFP battery material at a temperature in the range of from 250 °C to 500 °C, followed by oxidative roasting of the LFP battery material at a temperature in the range of from 500 °C to 700 °C. In some embodiments of the process, the oxidized LFP battery material obtained is subsequently leached with sulfuric acid and valuable materials are recovered from the solution obtained.

### DETAILED DESCRIPTION

A plant for recycling LFP battery material, e.g., used LFP batteries, is provided which comprises a comminuting device to comminute LFP battery material. The plant includes a heat treatment device, arranged downstream of the comminuting device, to dry the comminuted LFP battery material and subject it to a heat treatment in an inert or reductive atmosphere. The plant includes an oxidation device, arranged downstream of the heat treatment device, to oxidize the comminuted and heat-treated LFP battery material at an elevated temperature in an oxidative atmosphere.

In some embodiments, the plant provides for a first comminution of the used LFP battery material and a second comminution of the LFP battery material. The plant comprises a first comminuting device to comminute LFP battery material to a first degree of comminution in a first comminuting space. The plant includes a heat treatment device, arranged downstream of the first comminuting device, to dry the comminuted LFP battery material and subject it to a heat treatment. The plant includes a second comminuting device arranged downstream of the first comminution device and being configured to further comminute the heat-treated comminuted LFP battery material to a second degree of comminution in a second comminuting space, the second degree of comminution being greater than the first degree of comminution. In some embodiments, the plant further includes at least one separating device to separate particles of the comminuted LFP battery material of different particle sizes or particle size ranges from each other, i.e. to separate LFP battery material particles of different particle sizes or particle size ranges into two or more fractions of particles of correspondingly two or more different particle size ranges, e.g. to separate LFP battery material particles of a small particle size fraction from LFP battery material particles of a large particle size fraction. Preferably, the LFP battery material particles are separated by sieving.

In some embodiments, the second comminuting device is arranged downstream of the heat treatment device to further comminute the heat-treated comminuted LFP battery material to a second degree of comminution. The second degree of comminution is greater than the first degree of comminution provided by the first comminuting device. In some embodiments, a particle size of less than 20 mm is achieved in the first comminuting device, and a particle size in the range of 0.5-3 mm is achieved in the second comminuting device. In the context of the present disclosure, particle size designates the maximum particle size of all particles, i.e., all particles will pass through a sieve having a mesh size corresponding to the respective particle size.

It is to be noted that cathode active material (CAM) of LFP batteries detaching from current collector foils disintegrates as black mass into particles of <250 μm. However, the disintegration of the cathode active material is not actually a comminuting, but rather a deagglomeration. In the second comminuting device, the comminuted and heat-treated LFP battery material fed to the second comminuting device is subjected to mechanical pulping by comminution and subsequently to a palletization, so that a second black mass fraction with particles in the size range of <250 μm is obtained and the foils are present as pelleted particles of a size of 1-5 mm, preferably 0.5-3 mm.

In some embodiments, some or all components of the plant affected by a possible explosion, such as the first and/or second comminuting device, the heat treatment device, the intermediate storage device and/or the separating device, are designed to be explosion-proof. In some embodiments, at least the second comminuting device is designed to be explosion-proof.

In order to reduce the risk of self-ignition, in some embodiments an inert gas is supplied to at least some of the first comminuting device, the intermediate storage device, the heat treatment device, the second comminuting device and the at least one separating device. The inert gas is a gas that at least counteracts, if not even prevents, self-ignition of the comminuted batteries while the electrochemical reactions are taking place. For example, nitrogen gas and/or carbon dioxide gas can be used as the inert gas. The inert gas lowers a concentration of oxygen sufficiently. Thus, an explosion protection can be realized.

In terms of a mechanical design of the components of the plant affected by a possible explosion, some embodiments provide for greater wall thicknesses of the respective components and/or thicker bolts and nuts that prevent walls of the respective components from breaking so that they can withstand greater pressures, e.g. up to 10 bar over atmospheric pressure in case of danger of dust explosion. Thus, the respective components are designed to be shock pressure resistant. Depending on the respective dimensions of the respective components, their walls and the means provided for their cohesion, such as bolts, nuts etc., are chosen to be appropriately stable in order to withstand a pressure occurring in the event of a possible explosion in a calculable or assessable manner. In the case that shock pressure resistant components are coupled to non-shock pressure resistant components via valves, particularly rotary valves/feeder, those valves are also designed to be shock pressure resistant. Thereby, a complete plant area comprising components affected by a possible explosion can be designed to be shock pressure resistant and still be connected to the remaining plant components by means of the shock pressure resistant valves. Such complete plant area can be designed for a shock pressure up to 10 bar over atmospheric pressure in case of danger of dust explosion.

In some embodiments, at least the second comminuting device and its inlets and outlets including respective valves arranged at those inlets and outlets are designed to be shock pressure resistant.

In some embodiments, when using a rotor impact mill as second comminuting device, the circumferential speed or the tip speed of the mill is controlled and adjusted in a suitable manner, e.g. within a range of 20-120 meters per second (20 m/s-120 m/s), preferably 30-80 m/s, still more preferably 40-60 m/s. However, it is to be noted that the power impact depends on the construction size and the circumferential speed of the rotor impact mill and the material fed to the mill.

In still further embodiments, a shut-off valve, particularly a quick-closing valve is provided on some or every exhaust pipe/exhaust line of the plant. Alternatively or additionally, the length of some or all exhaust lines is selected in such a way that pressure can be relieved along the length of the respective exhaust line. It is to be noted that at least some of the first comminuting device, the heat treatment device, the second comminuting device and the pyrolysis device comprise at least one exhaust line. Pressure measuring means may be provided to detect the pressure prevailing in the plant, particularly in the respective components of the plant affected by a possible explosion and/or the respective exhaust pipes and to control the respective quick-closing valve(s)/flap(s).

The plant includes an intermediate storage device arranged between the (first) comminuting device and the heat treatment device. The volume of an intermediate storage space of the intermediate storage device is at least five times, preferably at least ten times, the volume of the comminuting space of the comminuting device. The intermediate storage device further comprises a stirring means configured to keep in motion the comminuted LFP battery material received in the intermediate storage space. The intermediate storage device assumes multiple functions in the plant according to the disclosure.

Firstly, the intermediate storage allows for electrochemical reactions taking place in the comminuted LFP battery material to subside to an extent that they do not create problems when the comminuted LFP battery material is supplied to the heat treatment device.

In addition, the intermediate storage device serves as a temporary store for comminuted LFP battery material. In this way, the plant of the present disclosure can be operated in a batch-wise manner, such that only small amounts of LFP battery material, e.g., used LFP batteries, needs to be supplied to the comminuting device in each batch, while a larger amount of comminuted LFP battery material can be supplied to the heat treatment device at once. Due to the small amount of material to be comminuted in one step, the risk of self-ignition can be practically excluded. This is particularly advantageous in the plant of the present disclosure when used LFP batteries that are supplied to the comminuting device have not been pre-discharged or at least not completely pre-discharged, and the residual charge of the LFP batteries, which drives the electrochemical reactions, is unknown.

And finally, freshly comminuted LFP battery material entering the intermediate storage space from the comminuting device are mixed by the stirring means with comminuted LFP battery material that was previously brought into the intermediate storage space, in which material the electrochemical reactions have at least partially subsided. This helps to avoid the formation of partial volumes of impermissibly high temperature having an increased risk of self-ignition.

All of these measures ensure that in the plant according to the disclosure, substantially unprepared used LFP batteries, in particular, used LFP batteries that are not or at least not completely pre-discharged and dismantled, can be recycled in a substantially automated and therefore cost-effective process.

In an exemplary plant, 1 ton of LFP battery material per hour can be recycled. LFP battery materials such as used LFP batteries are supplied to the comminuting device in the form of ten batches of 100 kg and temporarily stored in the intermediate storage device before they are passed on to the heat treatment device. In one embodiment, the comminuting space volume of the comminuting device is approximately 0.5 m³ and/or the intermediate storage space volume of the intermediate storage device is approximately 6.0 m³ and/or the heat treatment space volume of the heat treatment device is approximately 3.0 m³. It has to be taken into account that the comminuted LFP battery material is compacted by the conveying device, for example, a pipe screw conveyor, which transports the material from the intermediate storage device to the heat treatment device.

In order to prevent environmentally incompatible or even dangerous gases from escaping from the LFP battery recycling plant, it is proposed in a further embodiment of the plant that the comminuting space and/or the intermediate storage space and/or the heat treatment space are gas-tight.

In a further embodiment, the transfer device for transferring the comminuted LFP battery material from the comminuting device to the intermediate storage device and/or the transfer device for transferring the comminuted LFP battery material from the intermediate storage device to the heat treatment device is gas-tight and connected to the devices adjoining same in a gas-tight manner.

In a further embodiment, an exhaust gas treatment device is provided which is connected to the comminuting space and/or the intermediate storage space and/or the heat treatment space via gas supply lines and is configured to process the gases formed in the comminuting space and/or in the intermediate storage space and/or in the heat treatment space. The person skilled in the art is familiar with the components that the exhaust gas treatment device can or should comprise depending on the gas components produced. For this reason, a detailed discussion of the design and function of the exhaust gas treatment device can be dispensed with at this point.

In order to prevent excessively large fragments of the comminuted LFP battery material from exiting the comminuting device in the direction of the intermediate storage device, a sieve unit, for example a perforated sieve, is arranged at the outlet of the comminuting device in a further embodiment of the plant. In one embodiment, the openings of the sieve unit have a diameter of 20 mm. For instance, a universal shredder of the type NGU 0513, as sold by BHS Sonthofen GmbH, Germany, can be used as the comminuting device.

The heat treatment device is configured to receive the comminuted LFP battery material and subject it to a heat treatment in a heat treatment space provided within the heat treatment device. In some embodiments, the heat treatment device includes a supply line for supplying inert gas to the heat treatment space of the heat treatment device. In some embodiments of the plant, the heat treatment device comprises an oven, for instance, an electric oven.

In some embodiments of the plant, the heat treatment device comprises a rotary kiln. The rotary kiln is a cylindrical vessel, inclined slightly from the horizontal, which is rotated slowly about its longitudinal axis. The process feedstock is fed into the upper end of the cylinder. As the kiln rotates, material gradually moves down toward the lower end, and may undergo a certain amount of stirring and mixing.

In some embodiments of the plant, the kiln has a length in the range of from 12 to 18 m. In some embodiments of the plant, the kiln has a length in the range of from 15 to 17 m. Kiln length refers to the length of the heated zone of the kiln. Additional elements will make the overall kiln a little bit longer. In some embodiments of the plant, the inner diameter of the cylindrical tube is in the range of from 1.5 to 2.1 m, e.g., from 1.7 to 1.9 m.

In some embodiments of the plant, the rotary kiln features external heating elements using electric power. In some embodiments, the kiln comprises several heating zones. In some embodiments, thermoelements are provided in each of the heating zones for measuring the temperature in the respective zone. In one embodiment, each heating zone has a length in the range of from 0.5 m to 6 m, e.g., from 1 m to 4 m, for instance, from 1.5 to 3 m. In some embodiments, the heating zones of the kiln near the inlet are shorter than those near the outlet.

In some embodiments of the plant, the kiln connects with a material exit hood at the lower end and ducts for waste gases, and features gas-tight seals at both ends of the kiln. Equipment is installed to eliminate hydrocarbons from the exhaust gas stream of the kiln before passing the exhaust gas into the atmosphere.

An oxidation device is arranged downstream of the heat treatment device. The oxidation device is configured to receive the heat-treated LFP battery material from the heat treatment device and subject it to oxidative roasting in an oxidation space provided within the oxidation device. In some embodiments, the oxidation device includes a supply line for supplying oxygen-containing gas to the oxidation space of the oxidation device. In some embodiments of the plant, the oxidation device comprises an oven, for instance, a furnace or a kiln.

In some embodiments of the plant, the oxidation device comprises at least one rotary kiln. In some embodiments of the plant, the rotary kiln features internal heating comprising at least one burner. In some embodiments of the plant, the at least one rotary kiln is a directly heated kiln comprising at least one burner arranged inside the kiln.

In some embodiments, at least one separation device is arranged downstream of the comminuting device. In this separation device, the individual components of the comminuted LFP battery material can be separated from one another and thus supplied to a more targeted processing. In some embodiments, at least one separation device is arranged upstream of the heat treatment device. In this separation device, the comminuted LFP battery material obtained from the comminuting device can be separated into fractions having different particle sizes, and the fractions can be supplied to a more targeted downstream processing. For instance, coarse materials comprising parts of the battery housings or pieces of metal foils can be removed from the comminuted and dried LFP battery material to reduce energy consumption in the heat treatment and oxidation steps, respectively.

In some embodiments, at least one separation device is arranged downstream of the oxidation device. In this separation device, the oxidized LFP battery material obtained from the oxidation device can be separated into fractions having different particle sizes, and the fractions can be supplied to a more targeted downstream processing.

In some embodiments of the plant, a filling device is arranged downstream of the oxidation device. The filling device provides the oxidized LFP battery material for further processing. In some embodiments, the oxidized LFP battery material is filled into transport containers in this filling device. In some embodiments, at least one separation device is arranged upstream of the filling device and downstream of the oxidation device.

The present disclosure also provides a process for recycling LFP battery material. The process comprises
a) providing LFP battery material to a comminuting device,
b) comminuting the LFP battery material in the comminuting device to produce comminuted LFP battery material,
c) transferring the comminuted LFP battery material into a heat treatment device,
d) drying the comminuted LFP battery material and heating it to a temperature in the range of from 250 °C to 500 °C while contacting the comminuted and dried LFP battery material with an inert gas and with a reductive gas generated in situ by thermal decomposition of the comminuted LFP battery material,
e) transferring the heat-treated comminuted LFP battery material into an oxidation device,
f) oxidizing the heat-treated comminuted LFP battery material at a temperature of from 500 °C to 700 °C while contacting the heat-treated comminuted LFP battery material with an oxygen-containing gas to obtain an oxidized LFP battery material.

In some embodiments, the process additionally comprises the steps of
g) leaching the oxidized LFP battery material with sulfuric acid to obtain a solution comprising lithium ions and copper ions,
h) recovering copper from the solution obtained in step g), and
i) removing impurities from the solution obtained in step h) to obtain a solution comprising lithium ions.

At the start of the process, LFP battery materials such as used LFP batteries are provided to a comminuting device and then comminuted in the comminution device.

In some embodiments of the process, the LFP battery materials are at least one chosen from a lithium iron phosphate battery, lithium iron phosphate battery waste, lithium iron phosphate battery production scrap, lithium iron phosphate cell production scrap, lithium iron phosphate cathode active material, and combinations thereof.

Lithium iron phosphate batteries may be disassembled, punched, milled, for example in a hammer mill, rotor mill, and/or shredded, for example in an industrial shredder. From this kind of mechanical processing, the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D₅₀) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the used batteries employed in the process of the present disclosure. In some embodiments, the separation is done by manual or automated sorting. For example, magnetic parts can be separated by magnetic separation, non-magnetic metals can be separated by eddy-current separators. Other techniques may comprise air jigs and air tables.

The comminuted LFP battery material is transferred into a heat treatment device. In some embodiments of the process, the comminuted LFP battery material comprises an aluminum foil and a cathode active material. In some embodiments, the comminuted LFP battery material comprises copper, aluminum, lithium, iron, phosphorus, or combinations thereof.

In the heat treatment device, the comminuted LFP battery material is dried and heated to a temperature of 250 °C to 500 °C while contacting the comminuted LFP battery material with an inert gas and with a reductive gas generated in situ by thermal decomposition of the comminuted LFP battery material to obtain a heat-treated LFP battery material.

In some embodiments of the process, step b) comprises the steps of:
I. feeding the material to a first comminuting device and comminuting the material to obtain first particles having a maximum diameter of 50 mm or less;
II. feeding the first particles obtained in step I) to a second comminuting device and comminuting the first particles to obtain second particles having a maximum diameter of 20 mm or less;
III. feeding the second particles obtained in step II) to a first separating device to remove a first fine fraction consisting of particles having a size of <500 μm from the second particles;
IV. feeding the second particles obtained in step Ill) to a third comminuting device and comminuting the second particles to generate a second fine fraction consisting of particles having a size of <500 μm;
V. combining the first fine fraction and the second fine fraction.

The first and the second fine fraction, respectively, consist of particles having a size of <500 μm. In other words, all particles of the first and the second fine fraction, respectively, will pass through a sieve having a mesh width of 500 μm.

In some embodiments, step V. involves sieving the first fine fraction and the second fine fraction through a sieve having a mesh width of not more than 500 μm, e.g., 250 μm or less. In some embodiments, the particles remaining on the sieve are washed with water to remove residual fine fraction adhering to the particles remaining on the sieve.

In some embodiments of the process, calcium carbonate is added to the comminuted LFP battery material prior to transferring it into the heat treatment device. In some embodiments, a stoichiometric amount of calcium carbonate, relative of the total fluorine content of the comminuted LFP battery material, is added. For each mol of fluorine present, 0.5 mol of calcium carbonate are added. During heat treatment of the comminuted LFP battery material, the calcium carbonate reacts with fluorine present in the comminuted LFP battery material, thus trapping fluorine and preventing the formation of corrosive and toxic gases like hydrogen fluoride.

In some embodiments of the process, a mixture of calcium carbonate and magnesium carbonate is added to the comminuted LFP battery material prior to transferring it into the heat treatment device. In some embodiments, a stoichiometric amount of the calcium carbonate/magnesium carbonate mixture, relative of the total fluorine content of the comminuted LFP battery material, is added. For each mol of fluorine present, the molar amount calcium carbonate and magnesium carbonate added sums up to 0.5 mol (x mol CaCO₃+y mol MgCO₃=0.5 mol (CaCO₃+MgCO₃). In some embodiments, dolomite (CaMg(CO₃)₂) is added to the comminuted LFP battery material prior to transferring it into the heat treatment device. During heat treatment of the comminuted LFP battery material, the calcium carbonate/magnesium carbonate mixture reacts with fluorine present in the comminuted LFP battery material, thus trapping fluorine and preventing the formation of corrosive and toxic gases like hydrogen fluoride. It has been found that using a mixture of calcium carbonate and magnesium carbonate further increases the leaching efficiency for lithium and reduces the amount of iron in the leach solution.

In some embodiments, the process of the present disclosure comprises providing comminuted LFP battery material at a first temperature; heating the comminuted LFP battery material at a second temperature ranging from 250 °C to 500 °C, contacting the comminuted LFP battery material with an inert gas and with a reductive gas generated in situ by thermal decomposition of the comminuted LFP battery material to obtain a heat-treated LFP battery material.

In some embodiments, the process of the present disclosure comprises providing comminuted LFP battery material at a first temperature. In some embodiments of the process, the first temperature ranges from −50 °C to 50 °C, e.g., from −10 °C to 40 °C, for instance, from 0 °C to 30 °C. In a particular embodiment, the first temperature is ambient temperature.

In some embodiments of the process, the heat treatment step comprises a temperature ramp from the first temperature to the second temperature over a period of 10 minutes to 2 hours. In some embodiments of the process, the heat treatment step comprises a temperature ramp from the first temperature to the second temperature over a period of 30 minutes to 1.5 hour.

In some embodiments, a temperature ramp has average rate of temperature increase of at least 5 K per minute. In some embodiments, a temperature ramp has average rate of temperature increase of at least 10 K per minute. In some embodiments, a temperature ramp has average rate of temperature increase of at least 15 K per minute. In some embodiments, a temperature ramp has average rate of temperature increase of at least 20 K per minute. In some embodiments, a temperature ramp has average rate of temperature increase of at least 25 K per minute. In some embodiments, a temperature ramp has average rate of temperature increase of up to 50 K per minute.

In some embodiments, a temperature ramp has average rate of temperature increase ranging from 5 K per minute to 50 K per minute. In some embodiments, a temperature ramp has average rate of temperature increase ranging from 10 K per minute to 50 K per minute.

In some embodiments of the process, the heat treatment step comprises dwelling at the second temperature for a period of time ranging from 0 minutes to 1 hour, for instance, from 10 minutes to 45 minutes, or from 15 minutes to 30 minutes.

In some embodiments of the process, the heat treatment step comprises dwelling at one or more intermediate temperatures ranging from the first temperature to the second temperature.

In some embodiments, the process of the present disclosure comprises: providing comminuted LFP battery material at a first temperature ranging from −50 °C to 50 °C; heating the comminuted LFP battery material at a second temperature ranging from 250 °C to 500 °C; wherein the heating step comprises a temperature ramp from the first temperature to the second temperature over a period of time ranging from 10 minutes to 1 hour; dwelling at the second temperature for a time ranging from 0 minutes to 1 hour.

The process of the present disclosure comprises contacting the comminuted LFP battery material with an inert gas and with a reductive gas generated in situ by thermal decomposition of the comminuted and dried batteries to obtain a pyrolyzed battery material.

In some embodiments, the flow rate of the inert gas is in the range of from 100 to 300 Sm³/h, e.g. 150 to 250 Sm³, for instance, 200 Sm³/h (standard cubic meter per hour).

In some embodiments, the inert gas comprises at least one gas chosen from argon (Ar), dinitrogen (N₂), helium (He), and mixtures thereof.

In some embodiments, the reductive gas comprises at least one gas chosen from the group of hydrocarbons, dihydrogen gas (H₂), carbon monoxide (CO), and mixtures thereof.

In some embodiments of the process, the reductive gas comprises: from 5 volume % to 70 volume % C₁ to C₁₀ hydrocarbons, from 5 volume % to 95 volume % carbon dioxide (CO₂), from 0.1 volume % to 10 volume % carbon monoxide (CO), and from 0.1 volume % to 15 volume % H₂; wherein each volume % is by total volume of the reductive gas and the volume % of C₁ to C₁₀ hydrocarbons plus the volume % of CO₂ plus the volume % of H₂ is less than or equal to 100%.

In some embodiments of the process, the reductive gas comprises: from 5 volume % to 70 volume % C₁ to C₁₀ hydrocarbons, from 5 volume % to 45 volume % C₁ to C₁₀ oxy-hydrocarbons, and from 0.1 volume % to 15 volume % H₂; wherein each volume % is by total volume of the reductive gas and the volume % of C₁ to C₁₀ hydrocarbons plus the volume % C₁ to C₁₀ oxy-hydrocarbons plus the volume % of H₂ is less than or equal to 100%.

In some embodiments of the process, the heat treatment step is performed in a rotary kiln. In some embodiments of the process, the kiln is filled with a volume of comminuted LFP battery material equal to 5 to 20%, e.g., from 7% to 16%, for instance, from 8% to 12%, of the total volume of the kiln.

In some embodiments of the process, the comminuted LFP battery material is fed to the kiln using at least one screw conveyor.

In some embodiments of the process, the kiln rotates at 0.5 to 3 rpm. In some embodiments of the process, the kiln rotates at 1.4 to 2.6 rpm. In some embodiments of the process, the kiln rotates at 1.8 to 2.2 rpm.

In some embodiments of the process, overpressure is maintained in the kiln during operation to prevent air from entering the kiln.

In some embodiments of the process, hot gases pass along the kiln in the same direction as the process material (concurrent). In some embodiments of the process, the comminuted LFP battery material and an inert gas are fed to the rotary kiln in concurrent flow. The concurrent flow makes sure that no dust emerges from the upper end of the kiln.

In some embodiments of the process, the rotary kiln is heated by external heating elements using electric power. In some embodiments of the process, the kiln comprises several heating zones.

The heat-treated LFP battery material is transferred into an oxidation device and subsequently heated at a temperature of from 500 °C to 700 °C, e.g., from 550 °C to 650 °C, for instance, from 580 °C to 600 °C, while contacting the heat-treated LFP battery material with an oxygen-containing gas to obtain an oxidized LFP battery material. In some embodiments of the process, the oxidation step comprises dwelling at the temperature for a period of time ranging from 0 minutes to 2 hours, for instance, from 15 minutes to 105 minutes, or from 30 minutes to 90 minutes.

In the oxidation device, the heat-treated LFP battery material is contacted with an oxygen-containing gas. In some embodiments of the process, the oxygen-containing gas is air. In some embodiments of the process, the oxygen-containing gas is lean air, i.e., a mixture of nitrogen and oxygen having an oxygen content lower than 20.95 vol.-%. In some embodiments of the process, lean air having an oxygen content of less than 8 vol.-%, e.g., less than 5 vol.-%, for instance, 1 vol.-% to 3 vol.-%, is used. In some embodiments of the process, the oxygen-containing gas has an oxygen content of more than 21 vol.-%.

In some embodiments, the flow rate of the oxygen-containing gas is in the range of from 700 to 3,000 Sm³/h, e.g. from 750 to 2,500 Sm³/h, for instance, from 700 to 800 Sm³/h, or from 1,500 to 2,500 Sm³/h (standard cubic meter per hour).

In some embodiments, the oxidized LFP battery material comprises Li₃Fe₂(PO₄)₃ and Fe₂O₃ in a molar ratio of approximately 2:1, for instance, in a range from 1.8:1 to 2.2:1.

The present disclosure also provides a use of the oxidized LFP battery material of the present disclosure in the recovery of valuable materials from LFP battery materials, e.g., used LFP batteries. In some embodiments, the oxidized LFP battery material is used as an intermediate for a downstream leaching process.

In some embodiments of the process, the oxidized LFP battery material obtained from the oxidation step is subsequently leached with sulfuric acid to obtain an aqueous solution one or more value metal ions, e.g., a solution comprising lithium ions and copper ions. In some embodiments, the solution also comprises iron and phosphorus. In some embodiments, the solution also comprises impurities like nickel, cobalt, and/or manganese. The solution comprising one or more value metal ions may be further purified via, e.g., solvent exchange, ion-exchange, precipitation, extraction, and/or electrolysis.

In some embodiments of the process, the molar amount of sulfuric acid used to leach the oxidized LFP battery material is in the range of from 1.0*(0.5 times the molar amount of lithium plus the molar amount of copper) to 2.0*(0.5 times the molar amount of lithium plus the molar amount of copper) present in the oxidized LFP material, as determined by elemental analysis. In some embodiments of the process, the molar amount of sulfuric acid used to leach the oxidized LFP battery material is in the range of from 1.0*(0.5 times the molar amount of lithium plus the molar amount of copper) present in the oxidized LFP material, as determined by elemental analysis, to 1.5*(0.5 times the molar amount of lithium plus the molar amount of copper). It has been found that when an excess amount of sulfuric acid is present in the leaching step, substantial amounts of iron and phosphorus are leached from the oxidized LFP battery material.

In some embodiments of the process, leaching is performed at a temperature of from 90 °C to 100 °C, for instance, 95 °C to 100 °C, e.g., 98 to 100 °C. It has been found that high temperatures substantially increase the selectivity of the leaching process for lithium and copper; and less iron and phosphorus are dissolved. Moreover, iron (III) phosphate (FePO₄) is formed which precipitates from the solution.

In some embodiments of the process, the weight ratio of liquid to solids in the leaching step is in the range of from 3:1 to 6:1, for example, from 3:1 to 5:1, e.g., from 3:1 to 4:1. It has been found that employing a weight ratio of liquid to solids in the specified range substantially increases the selectivity of the leaching process for lithium and copper; and less iron and phosphorus are dissolved.

In some embodiments of the process, the duration of the leaching step is in the range of from 30 minutes to 3 hours, e.g., 2 hours.

Subsequent to the leaching step, the solution formed is separated from the solids, e.g., by filtration or sedimentation.

In some embodiments of the process, copper is recovered from the solution comprising lithium ions and copper ions. In some embodiments of the process, copper (Cu⁰) is recovered from the solution by cementation with iron powder (Fe⁰). In some embodiments of the process, copper is recovered from the solution by precipitation of copper sulfide (CuS) from the solution. In some embodiments of the process, copper is recovered from the solution by solvent extraction.

In some embodiments of the process, impurities are recovered from the solution depleted of copper ions. In some embodiments of the process, the pH value of the solution is raised to a value in the range of from-PPT pH≈10-11 to precipitate the impurities. In some embodiments of the process, tetrafluoroaluminate [AlF₄]⁻ is added to the solution to precipitate the impurities.

In some embodiments of the process, impurities are removed by ion exchange using an cation exchanger loaded with calcium ions, resulting in the precipitation of calcium salts from the solution.

After removal of impurities, a solution comprising lithium ions is obtained. In some embodiments of the process, the solution is directly used as a feed for chemical reactions, e.g., the preparation of cathode active materials (CAM) for batteries. In some embodiments of the process, lithium carbonate is precipitated from the solution. In some embodiments of the process, lithium phosphate is precipitated from the solution.

### EXAMPLES

### Example 1

Three separate batches of 150 g LFP cathode material were filled into ceramic crucibles which were placed into a muffle furnace and heated to 450 °C within 2 hrs. During heating, the air inlet of the furnace was opened and air was allowed to pass through the chamber with an undefined flow rate. After holding the temperature at 450 °C for 2 h and then cooling to ambient temperature, the products were combined and a total amount of 456.7 g was obtained.

Leaching with Different Solid-to-Liquid Ratios

20 g of the product were dispersed in a) 94.3 g b) 74.3 g c) 54.3 g deionized water and heated to 100 °C with stirring. 5.7 g of 96% sulfuric acid were slowly added within 15 minutes to all three reaction vessels. After 2 h at 100 °C, the mixtures were allowed to cool to ambient temperature and then filtrated to remove the solids. After washing with 20 mL deionized water and drying under reduced pressure a) 21.1 g b) 21.3 g c) 21.7 g solid residue were obtained. Lithium, iron, and phosphorus were leached with an efficiency of a) 95.1%, 0.3%, and 7.8%; b) 97.9%, 0.2%, and 7.0%; c) 92.3%, 0.1%, and 5.1%, respectively.

### Leaching at Different Temperatures

20 g of the product were dispersed in 94.3 g deionized water and d) stirred at room temperature e) heated to 40 °C with stirring f) heated to 70 °C with stirring. 5.7 g of 96% sulfuric acid were slowly added within 15 minutes to all three reaction vessels. After 2 h at the respective temperatures, the mixtures were allowed to cool to ambient temperature and then filtrated to remove the solids. After washing with 20 mL deionized water and drying under reduced pressure d) 14.3 g e) 16.3 g f) 17.0 g solid residue were obtained. Lithium, iron, and phosphorus were leached with an efficiency of d) 59.5%, 21.8%, and 37.7%; e) 67.4%, 14.7%, and 29.5%; f) 67.1%, 11.9%, and 26.2%, respectively.

### Example 2 (Comparative)

20 g mixed electrode material from LFP battery waste were dispersed in a) 96.5 g b) 92.9 g c) 89.4 g d) 80.0 g deionized water and heated to 100 °C with stirring. a) 3.5 g b) 7.1 g c) 10.6 g d) 20.0 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure a) 14.3 g b) 10.7 g c) 7.3 g d) 7.5 g solid residue were obtained. Lithium, iron, phosphorus and copper were leached with an efficiency of a) 50.8%, 36.8%, 32.5%; and 0.0%, b) 87.2%, 84.9%, 71.2%; and 0.0%, c) 97.9%, 97.9%, 96.7%; and 0.0%, d) 98.0%, 98.2%, 97.3%, and 0.0%, respectively.

### Example 3 (Comparative)

50 g mixed electrode material from LFP battery waste comprising 3.5 wt.-% of fluorine, relative to the total weight of the mixed electrode material, were placed into a quartz glass rotary kiln and heated to 500 °C within 2 h. During heating, the kiln remained stationary and air was passed through it with a flow rate of 30 L/h. After holding the temperature at 500 °C for 2 h and then cooling the kiln to ambient temperature, 44.3 g of a reddish-brown solid were obtained as product. The volatile products generated during the heat treatment were passed through an aqueous KOH solution (10 wt.-%). The fluorine content of the KOH solution was determined afterwards and it was found that 68.6% of the initial fluorine content of the mixed LFP electrode material had been volatilized.

### Leaching

20 g of the product were dispersed in a) 89.4 g b) 96.0 g deionized water and heated to 100 °C with stirring. a) 10.6 g b) 4 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure a) 9.4 g b) 17.9 g solid residue were obtained. Lithium, iron, and phosphorus were leached with an efficiency of a) 91.5%, 62.6%, and 73.1%; b) 89.3%, 7.7%, and 18.0%, respectively. For a), copper could be leached with an efficiency of 78.2%.

### Example 4 (Comparative)

50 g mixed electrode material from LFP battery waste comprising 3.5 wt.-% fluorine, relative to the total weight of the mixed electrode material, were placed into a quartz glass rotary kiln and heated to 500 °C within 2 h. During heating, the kiln remained stationary and inert gas was passed through it at a flow rate of 30 L/h. After holding the temperature at 500 °C for 2 h and then cooling the kiln to ambient temperature, 45.1 g of a black solid were obtained as product. The volatile products generated during the heat treatment were passed through an aqueous KOH solution (10 wt.-%). The fluorine content of the KOH solution was determined afterwards and it was found that 91.4% of the initial fluorine content of the mixed LFP electrode material had been volatilized.

### Leaching

20 g of the product were dispersed in 96.0 g deionized water and heated to 100 °C with stirring. 4 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure 14.5 g solid residue were obtained. Lithium, iron, and phosphorus were leached with an efficiency 45.3%, 36.9%, and 34.8%, respectively.

### Example 5 (Comparative)

100 g mixed electrode material from LFP battery waste comprising 0.27 wt.-% fluorine, relative to the total weight of the mixed electrode material, were placed into a quartz glass rotary kiln and heated to 600 °C within 105 min. During heating, the kiln was rotated (1 rpm) and air was passed through it at a flow rate of 40 L/h. After holding the temperature at 600 °C for 16 h and then cooling the kiln to ambient temperature, 73.0 g of a reddish-brown solid were obtained as product. The volatile products generated during the heat treatment were passed through an aqueous KOH solution (10 wt.-%). The fluorine content of the KOH solution was determined afterwards and it was found that 94.3% of the initial fluorine content of the mixed LFP electrode material had been volatilized.

### Leaching

20 g of the product were dispersed in a) 96.0 g b) 90.0 g deionized water and heated to 100 °C with stirring. a) 4.0 g b) 10.0 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure a) 16.4 g b) 14.5 g solid residue were obtained. Lithium, iron, phosphorus, and copper were leached with an efficiency of a) 69.1%, 13.6%, 25.4%; and 31.5%, b) 94.6%, 28.4%, 16.1%, and 78.1%, respectively.

### Example 6

101.4 g mixed electrode material from LFP battery waste comprising 4.15 wt.-% fluorine, relative to the total weight of the mixed electrode material, with an added amount of CaCO₃ in the exact stoichiometry to bind all fluorine as CaF₂, were placed into a quartz glass rotary kiln and heated to 600 °C within 105 min. During heating, the kiln was rotated (1 rpm) and air was passed through it at a flow rate of 40 L/h. After holding the temperature at 600 °C for 7.5 h and then cooling the kiln to ambient temperature, 72.9 g of a reddish-brown solid were obtained as product. The volatile products generated during the treatment were passed through an aqueous KOH solution (10 wt.-%). The fluorine content of the KOH solution was determined afterwards and it was found that 2.3% of the initial fluorine content of the mixed LFP electrode material had been volatilized.

### Leaching

20 g of the product were dispersed in a) 93.5 g b) 87.0 g deionized water and heated to 100 °C with stirring. a) 6.5 g b) 13 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure a) 20.0 g b) 16.8 g solid residue were obtained. Lithium, iron, phosphorus, and copper were leached with an efficiency of a) 90.0%, 7.6%, 8.7%, and 50.3%, b) 95.2%, 32.3%, 31.1%, and 94.2%, respectively.

### Example 7

50.9 g mixed electrode material from LFP battery waste comprising 3.5 wt.-% fluorine, relative to the total weight of the mixed electrode material, with an added amount of CaCO₃ in the exact stoichiometry to bind all fluorine in form of CaF₂, were placed into a quartz glass rotary kiln. The reaction vessel was put under inert atmosphere and heated with a rate of 15 K/min to a first temperature of 300 °C. After a holding time of 20 min at 300 °C, the temperature was increased to 550 °C within 20 min. Then the inert gas was substituted by air, which was introduced into the vessel at a flow rate of 50 L/h. After holding the temperature at 550 °C for another 1 h and then cooling the kiln to ambient temperature, 43.2 g of a reddish-brown solid were obtained as product. During heating, the kiln was rotated (1 rpm) and the volatile products generated during the heat treatment were passed through an aqueous KOH solution (10%). The fluorine content of the KOH solution was determined afterwards and it was found that none of the initial fluorine content of the mixed LFP electrode material had been volatilized.

### Example 8

Example 7 was repeated with a larger amount of mixed electrode material from LFP battery waste. 250 g of the product obtained were filled into a ceramic crucible which was placed into a muffle furnace and heated to 500 °C within 100 min. During heating, the air inlet of the furnace was opened and air was allowed to pass through the chamber with an undefined flow rate. After holding the temperature at 500 °C for 1 h and then cooling to ambient temperature, 238.2 g of a reddish-brown solid were obtained as product.

### Leaching

20 g of the product were dispersed in 90.0 g deionized water and heated to 100 °C with stirring. 10.0 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure 15.8 g solid residue were obtained. Lithium, iron, phosphorus, and copper were leached with an efficiency of 94.5%, 37.1%, 37.0%, and 97.9%, respectively.

### Example 9

76.4 g mixed electrode material from LFP battery waste comprising 3.5 wt.-% fluorine, relative to the total weight of the mixed electrode material, with an added amount of CaCO₃ in the exact stoichiometry to bind all fluorine in form of CaF₂, were placed into a quartz glass rotary kiln. The reaction vessel was put under inert atmosphere and heated with a rate of 5 K/min to a first temperature of 300 °C. After a holding time of 60 min at 300 °C, the inert gas was substituted by air, which was introduced into the vessel at a flow rate of 50 L/h and the temperature was increased to 600 °C within 60 min. After holding the temperature at 600 °C for another 6 h and then cooling the kiln to ambient temperature, 53.9 g of a reddish-brown solid were obtained as product. During heating, the kiln was sporadically rotated manually, and the volatile products generated during the treatment were passed through an aqueous KOH solution (10%). It was found that 2.9% of the initial fluorine content of the mixed LFP electrode material had been volatilized.

### Leaching

20 g of the product were dispersed in 94.7 g deionized water and heated to 100 °C with stirring. 5.3 g of 96% sulfuric acid were slowly added within 15 minutes. After 2 h at 100 °C, the mixture was allowed to cool to ambient temperature and then filtrated to remove the solids. After washing with 20 mL deionized water and drying under reduced pressure 18.5 g solid residue were obtained. Lithium, iron, phosphorus, and copper were leached with an efficiency of 83.9%, 4.4%, 19.1%, and 52.4%, respectively.

### Example 10

LFP battery waste was mixed with a one- or two-component earth alkaline F-scavenger (SCV) system in a stoichiometric ratio of 1.6:1-2.1:1 Fluoride to earth alkaline metal (F:M_{EA}). The compositions of the starting materials used are shown in Tables 1 and 2.

TABLE 1

| BM | C | F | Al | Cu | Fe | Li | Mg | P |
|---|---|---|---|---|---|---|---|---|
| 1 | 28.50% | 3.50% | 2.10% | 5.40% | 17.20% | 2.40% | 0.01% | 12.0% |
| 2 | 41.40% | 3.60% | 1.90% | 2.40% | 13.70% | 2.20% | 0.03% | 8.30% |

TABLE 2

| | | | SCV 1 | | SCV 2 | | | |
|---|---|---|---|---|---|---|---|---|
| Trial | BM | SCV 1 | [g] | SCV 2 | [g] | F:M_{EA} | F_{before} | F_{after} |
| I | 1 | / | / | MgO | 1.5 | 2.05:1 | 3.5% | 3.7% |
| II | 1 | CaCO₃ | 9.4 | / | / | 1.96:1 | 3.5% | 3.3% |
| III | 2 | CaCO₃ | 5.2 | MgCO₃ | 4.4 | 1.63:1 | 3.2% | 3.7% |
| IV* | 2 | / | / | / | / | / | / | / |
| V* | 1 | / | / | / | / | / | 3.5% | 0.3% |

*comparative examples

The material was placed into a quartz glass reaction vessel and was first heat treated under inert conditions at a temperature of 300-550 °C for 1-2 h and subsequently roasted under aerobic conditions at 500-550 °C for 1-2 h.

Fluoride remained quantitatively in the solid (>95%) in trials I-III. The conditions for trial IV were kept analogous except no additional scavenger was added. In trial V no scavenger was added, and the LFP battery waste material was heat treated under inert conditions at a temperature of 500 °C for 2 h. All products were obtained as a reddish brown solid.

### Leaching Example A

20 g of product I were dispersed in 92.5 g deionized water and heated to 100 °C under stirring. 7.5 g of 96% sulfuric acid were slowly added within 15 minutes. After 2 h at 100 °C, the mixture was allowed to cool to ambient temperature and then filtrated to remove the solids. After washing with deionized water and drying under reduced pressure 18.8 g solid residue and 105.1 g leach solution could be obtained.

### Leaching Example B

20 g of product II were dispersed in 92.5 g deionized water and heated to 100 °C under stirring. 7.5 g of 96% sulfuric acid were slowly added within 15 minutes. After 8 h at 100 °C, the mixture was allowed to cool to ambient temperature and then filtrated to remove the solids. After washing with deionized water and drying under reduced pressure 20 g solid residue and 103.8 g leach solution could be obtained.

### Leaching Example C

20 g of product III were dispersed in 110 g deionized water and heated to 100 °C under stirring. 10 g of 96% sulfuric acid were slowly added within 15 minutes. After 3 h at 100 °C, the mixture was allowed to cool to ambient temperature and then filtrated to remove the solids. After washing with deionized water and drying under reduced pressure 19 g solid residue and 117.6 g leach solution could be obtained.

### Leaching Example D

20 g of product IV were dispersed in 110 g deionized water and heated to 100 °C under stirring. 10 g of 96% sulfuric acid were slowly added within 15 minutes. After 3 h at 100 °C, the mixture was allowed to cool to ambient temperature and then filtrated to remove the solids. After washing with deionized water and drying under reduced pressure 18 g solid residue and 115.9 g leach solution could be obtained.

Leaching efficiencies measured are shown in Table 3, compositions of the leach solutions obtained are shown in Table 4.

TABLE 3

| Trial | Li-LE | Fe-LE | P-LE | F-LE | Mg-LE |
|---|---|---|---|---|---|
| A | 95.6% | 5.7% | 8.1% | / | 41.3% |
| B | 91.8% | 14.1% | 5.5% | / | / |
| C | 96.8% | 4.3% | 6.4% | 47.3% | 25.3% |
| D | 92.3% | 7.5% | 8.2% | 77.9% | / |

TABLE 4

| Trial | Li | Fe | P | Cu | F | Ca | Mg |
|---|---|---|---|---|---|---|---|
| A | 0.51% | 0.22% | 0.18% | 0.49% | n.d. | n.d. | 0.20% |
| B | 0.46% | 0.55% | 0.13% | 0.83% | n.d. | n.d. | n.d. |
| C | 0.39% | 0.11% | 0.10% | 0.48% | 0.29% | 0.049% | 0.064% |
| D | 0.41% | 0.21% | 0.14% | 0.53% | 0.47% | n.d. | n.d. |

### Analytical Methods

### Determination of Leaching Efficiencies

Leaching efficiencies (LE) were determined using element contents determined by ICP-OES. If not stated otherwise, leaching efficiencies were determined by using the element content determined in the mother liquor.

The following formulas were utilized:

$$\frac{m ( {E}_{ML} )}{m ( {E}_{Max} )} = {LE}_{E} \qquad ( 1 )$$

$$m ( {E}_{ML} ) = \frac{{E}_{ICP - ML} * m ( ML )}{100} \qquad ( 2 )$$

wherein
E denotes a given element,
ML denotes the mother liquor,
E_{ICP-ML} is the determined percentage-based content in the mother liquor,
m(E_{ML}) is the weight content of the element in the mother liquor,
m(E_{Max}) is the maximum yield of an element based on the amount of the element in the solid before leaching, and
LE_{E} is the leaching efficiency of the respective element.

In examples 2c, 2d, and 6b, the leaching efficiencies were determined from the filter residue.

All calculations are analogous to equations (1) and (2), except for substituting every instance of ML with FC (filter cake). The corresponding LE_{E} is:

$$1 - \frac{m ( {E}_{FC} )}{m ( {E}_{Max} )} = {LE}_{E} \qquad ( 3 )$$

### Proportion of Volatilized Fluorine

All calculations were performed using elemental contents determined by ICP-OES. Fluoride volatilization was either examined by analyzing fluorine content of the solid before and after thermal treatment, or by additionally analyzing fluorine content of the 10% KOH scrubber liquid.

$$\frac{m ( {F}_{Product} )}{m ( {F}_{Input} )} = {F}_{\%} \qquad ( 4 )$$

F % is then the percentage of fluoride in either the solid or the scrubber liquid, respectively.

### Elemental Analysis

This section describes the analytical methods used for the quantitative determination of the constituents of the composite material of the present disclosure.

### Fluorine Content

The determination of fluorine uses a combination of combustion and measurement by a fluoride ion-selective electrode.

### Combustion

Approximately 1-100 mg of the sample were weighed into a combustion boat. For sample weighing and transfer, a capsule made of gelatine or tin can be used. V₂O₅ was added to promote the combustion. The boat was introduced via a sample application device into a combustion tube heated to ~1.000-1.100 °C. The sample was combusted in an oxygen stream containing water steam. During combustion, fluorine containing components formed hydrogen fluoride. The combustion gases, containing the formed hydrogen fluoride, were absorbed in an absorption solution. A total ionic strength adjustment buffer, (e.g., TISAB IV buffer solution (ASTM D 1179)) was used as absorption solution. The solution was transferred to the ion-sensitive measuring cell and filled up to 50 mL using TISAB and ultrapure water (1:1).

The combustion system used was a Mitsubishi AQF-2100H automatic quick furnace (a1-envirosciences GmbH, 40595 Dusseldorf, Germany).
Oven inlet temperature: ~1.000 °C
Oven outlet temperature: ~1.100 °C
Combustion gas (oxygen): ~200 mL/min
Carrier gas (argon): ~100 mL/min
Water flow: 0.2 mL/min

### Detection by Fluoride Ion-Selective Electrode

In the absorption solution, fluoride was measured by means of a fluoride ion-selective electrode (e.g., ISE 6.0502.150, Deutsche Metrohm GmbH & Co. KG, 70794 Filderstadt, Germany). For quantification, external calibration of the elec-trode was performed using fluoride standard solutions of different concentrations, e.g. 0.1, 1.0, 10 and 100 mg/L fluoride. The calibration solutions were automatically prepared by diluting a fluoride stock solution with TISAB solution and ultrapure water (1:1).

### Metal Content

Elemental analysis was performed using a combination of acid dissolution and alkaline-borate fusion digestion with analysis by inductively coupled plasma optical emission spectrometry (ICP-OES) on an inductively coupled plasma optical emission spectrometer (e.g., Agilent 5110 ICP-OES, Agilent Technologies Germany GmbH & Co. KG, 76337 Waldbronn, Germany).

An aliquot (e.g., about 0.2 g) of the sample material was weighed into a volumetric flask and dissolved under slight heating with 30 ml HCl. After cooling down, the insoluble residue was filtered out and incinerated together with the filter paper in a Pt crucible above an open flame. Subsequently, the residue was calcinated at about 600 °C in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in deionized (DI) water under slight heating and 12 ml of HCl were added. Finally, the solution was joined to the initial filtered solution in the volumetric flask and topped up to its final volume with DI water. Each sample was prepared in triplicate. A blank sample was prepared in an analogous manner.

The digestion solution was analyzed by inductively coupled plasma-optical emission spectrometry (ICP-OES), using external calibration. For some samples, the digestion solution may be diluted before analysis, e.g., adapted to the concentration and calibration range of the respective analyte.

### Phosphorus Content

Phosphorus content was determined by a combination of acid dissolution and alkaline-borate fusion digestion with subsequent measurement via inductively coupled plasma optical emission spectrometry (ICP-OES).

An aliquot between 0.13 g and 0.18 g of the sample material was weighed into a volumetric flask and dissolved under slight heating with HCl (approx. 6 mol/1). After cooling down, the insoluble residue was filtered out and incinerated together with the filter paper in a Pt crucible above an open flame. Subsequently, the residue was calcinated at approx. 600 °C in a muffle furnace and then mixed with 1.0 g of a K₂CO₃—Na₂CO₃/Na₂B₄O₇ flux mixture (4:1) and melted above an open flame until a clear melt was obtained. After cooling down, the melt cake was dissolved in DI water under slight heating and 12 ml of HCl were added. Finally, the solution was joined to the initial filtered solution in the volumetric flask and the volume was completed to 100 ml with DI water. Each sample was prepared in triplicate. A blank sample was prepared in an analogous manner.

The digestion solution was analyzed by inductively coupled plasma-optical emission spectrometry (ICP-OES) using and ICP-OES spectrometer (Agilent 5110 ICP-OES, Agilent Technologies Germany GmbH & Co. KG, 76337 Waldbronn, Germany) at wavelength: P (R) 178.222 nm, internal standard: Sc (R) 361.383 nm, Calibration: External, Dilution: 1 (direct measurement).

### Carbon Content

Carbon content was determined by elemental analysis in an automated analyzer (vario EL Cube, Elementar Analysensysteme GmbH, 63505 Langenselbold, Germany). The sample (2-3 mg) was weighed into a tin capsule. The capsule with the sample was combusted in a helium/oxygen atmosphere at approximately 1100 °C using copper oxide as combustion catalyst. After separation of the combustion gases via chromatography, carbon was determined as CO₂. The detection and quantification was performed via measurement of thermal conductivity using a TCD.

1. A plant for recycling lithium iron phosphate (LFP) battery materials, comprising i) a comminuting device to comminute LFP battery materials in a comminuting space, ii) a heat treatment device, arranged downstream of the comminuting device, configured to receive the comminuted LFP battery material and subject it to a heat treatment in an inert or reductive atmosphere in a heat treatment space provided within the heat treatment device, iii) an intermediate storage device arranged between the comminuting device and the heat treatment device, comprising a stirring means configured to keep in motion the comminuted LFP battery material received in an intermediate storage space of the intermediate storage device, and iv) an oxidation device arranged downstream of the heat treatment device configured to receive the heat-treated LFP battery material from the heat treatment device configured to oxidize the comminuted and heat-treated LFP battery material at an elevated temperature in an oxidative atmosphere in an oxidation space provided within the oxidation device.

2. The plant of claim 1, further comprising v) at least one reactor for recovering valuable materials from the oxidized LFP battery material.

3. The plant of claim 1, wherein the heat treatment device comprises a rotary kiln.

4. The plant of claim 1, wherein the oxidation device comprises at least one rotary kiln.

5. The plant of claim 4, wherein the at least one rotary kiln is a directly heated kiln comprising at least one burner arranged inside the kiln.

6. The plant of claim 1, further comprising vi) at least one separation device arranged downstream of the comminuting device.

7. The plant of claim 6, wherein the at least one separation device is arranged downstream of the oxidation device.

8. The plant of claim 1, further comprising vii) a filling device arranged downstream of the oxidation device.

9. The plant of claim 1, further comprising i1) a first comminuting device to comminute LFP battery material to a first degree of comminution in a first comminuting space, and i2) a second comminuting device arranged downstream of the first comminution device and being configured to further comminute the LFP battery material to a second degree of comminution in a second comminuting space, the second degree of comminution being greater than the first degree of comminution.

10. A process for recycling LFP battery material, comprising
a) providing LFP battery material to a comminuting device,
b) comminuting the LFP battery material in the comminuting device to produce comminuted LFP battery material,
c) transferring the comminuted LFP battery material into a heat treatment device,
d) drying the comminuted LFP battery material and heating it to a temperature in a range of from 250 °C to 500 °C while contacting the comminuted and dried LFP battery material with an inert gas and with a reductive gas generated in situ by thermal decomposition of the comminuted LFP battery material,
e) transferring the heat-treated comminuted LFP battery material into an oxidation device, and
f) oxidizing the heat-treated comminuted LFP battery material at a temperature of from 500 °C to 700 °C while contacting the heat-treated comminuted LFP battery material with an oxygen-containing gas to obtain an oxidized LFP battery material.

11. The process of claim 10, further comprising the steps of
g) leaching the oxidized LFP battery material with sulfuric acid to obtain a solution comprising lithium ions and copper ions,
h) recovering copper from the solution obtained in step g), and
i) removing impurities from the solution obtained in step h) to obtain a solution comprising lithium ions.

12. The process of claim 10, wherein a stoichiometric amount of calcium carbonate, relative of the total fluorine content of the comminuted LFP battery material, is added to the comminuted LFP battery material prior to transferring it into the heat treatment device.

13. The process of claim 11, wherein the molar amount of sulfuric acid used to leach the oxidized LFP battery material is in a range of from 1.0*(0.5 times the molar amount of lithium plus the molar amount of copper) to 2.0*(0.5 times the molar amount of lithium plus the molar amount of copper) present in the oxidized LFP material, as determined by elemental analysis.

14. The process of claim 11, wherein the weight ratio of liquid to solids in the leaching step g) is in a range of from 3:1 to 6:1.

15. The process of claim 11, wherein the leaching step g) is performed at a temperature of from 95 °C to 100 °C.
